(19) United States
(12) Patent Application Publication
(10) Pub. No.: US 2026/0175869 A1
(43) Pub. Date: Jun. 25, 2026

(54) SENSOR UTILITY BASED ON VEHICLE POSITION

(71) Applicant: Zoox, Inc., Foster City, CA (US)

(72) Inventors: Till Kroeger, Chicago, IL (US); Dhruv Maheshbhai Patel, Foster City, CA (US); Joseph P. W. Whinnery, Soquel, CA (US)

(21) Appl. No.: 19/000,280

(22) Filed: Dec. 23, 2024

(51) Int. Cl. B60W 60/00; B60W 10/22; B60W 50/00

(52) U.S. Cl. CPC B60W 60/001; B60W 10/22; B60W 50/0097; B60W 2556/20; B60W 2556/40

(57) ABSTRACT

Techniques for vehicle positioning to optimize or improve sensor utility are described herein. A vehicle may receive sensor data of an environment. The vehicle can use the sensor data to detect relevant objects (e.g., traffic signs, traffic lights, construction signs, construction workers, buildings, etc.) proximate the vehicle. Further, vehicle can use the sensor data to detect blocking objects or objects that block the sensor field of view (e.g., busses, semi-trucks, trailers, etc.) proximate the vehicle. The vehicle may generate candidate actions and evaluate such candidate actions (e.g., determine cost values) based on whether the blocking object(s) occlude the relevant object(s) from the one or more sensor devices of the vehicle. The vehicle can be controlled based on such evaluations (e.g., follow the candidate actions, generate modified actions to increase view of the relevant object(s), etc.).

### BACKGROUND

Vehicles, such as autonomous vehicles, may navigate along designated routes. In some examples, the vehicles may encounter various types of objects and/or anomalies along the routes. However, in some circumstances, techniques for optimizing vehicle positioning proximate such objects and/or anomalies may result in inaccurate and/or suboptimal results.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial flow diagram illustrating an example technique for improving sensor utility based on vehicle positioning, in accordance with one or more examples of the disclosure.

FIG. 2 illustrates an example computing system including a planning component configured to determine positions in an environment for a vehicle to increase the quality and/or utility of captured sensor data, in accordance with one or more examples of the disclosure.

FIG. 3 is flow diagram illustrating an example process for modifying a vehicle route to avoid degradation in sensor data quality and/or capabilities, in accordance with one or more examples of the disclosure.

FIG. 4 depicts a block diagram of an example system for implementing various techniques described herein.

FIG. 5 is a flow diagram illustrating an example process for detecting relevant object(s) and blocking object(s), generating a candidate trajectory, determining occluded region(s) based on the blocking object(s) and the candidate trajectory, and determining a modified trajectory based on the occluded region(s) and the relevant object(s), in accordance with one or more examples of the disclosure.

### DETAILED DESCRIPTION

Techniques for vehicle positioning to optimize sensor utility are described herein. For example, a vehicle (such as an autonomous vehicle) may receive sensor data of an environment. The vehicle can use the sensor data to detect relevant objects (e.g., traffic signs, traffic lights, construction signs, construction workers, buildings, etc.) proximate the vehicle. The vehicle can use the sensor data to detect blocking objects or objects that block the sensor field of view (e.g., busses, semi-trucks, trailers, other vehicles, etc.) proximate the vehicle. In some examples, the vehicle may generate candidate actions and evaluate such candidate actions (e.g., determine cost values) based on whether the blocking object(s) occlude the relevant object(s) from the one or more sensor devices of the vehicle. In such cases, the vehicle can be controlled based on such evaluations (e.g., follow the candidate actions, generate modified actions to increase view of the relevant object(s), etc.). As described in more detail below, the techniques described herein may improve vehicle safety and driving efficiency by positioning the vehicle in locations within the environment that optimize the amount of sensor data the sensor devices can capture, the quality of sensor data the sensor devices can capture, and/or the usefulness of the sensor data that the sensor devices can capture, thereby allowing the vehicle to determine more precise and/or accurate localization data and/or to plan vehicle actions based on more accurate and complete knowledge of objects in the environment.

When navigating an environment, it may be beneficial to consider how to position the vehicle in the environment to optimize or improve senser device utility while complying with other vehicle operating constraints (e.g., rules of the road, etc.). For example, a vehicle navigating an environment may capture sensor data of the environment. The vehicle may detect various types of objects (e.g., static objects) to use when localizing the vehicle within the environment. However, in some cases, while navigating the environment, the vehicle may travel near large delivery trucks, semi-trucks, busses, trailers, etc. which may cause a significant portion of the surrounding environment (and those highly relevant objects) to become occluded, thereby limiting the ability of the vehicle to perform localization tasks, plan optimal vehicle actions, etc. Further, in other examples, low sun angles, wet pavement glare, etc. can also degrade the quality of sensor devices such that the sensor devices are unable to view the surrounding environment or sensor data captured by the sensor devices may be degraded. As such, the techniques and/or systems described herein include determining vehicle locations within the environment to increase the utility and/or field of view of the sensor devices.

To address these and other technical problems and inefficiencies, the systems and/or techniques described herein include a planning component (which also may be referred to as a “planning system” or “planner component”) configured to determine vehicle positions in the environment relative to blocking objects to increase the amount and/or quality of sensor data captured of the relevant object(s). Technical solutions discussed herein solve one or more technical problems by minimizing areas and/or relevant objects that are occluded from vehicle sensor(s) and/or minimizing an amount of time that relevant object(s) are occluded from vehicle sensor(s).

In some examples, the planning component may receive sensor data representative of an environment. That is, the vehicle may capture sensor data while navigating an environment. The vehicle may include one or more sensor device(s) (e.g., lidar device(s), radar device(s), time-of-flight device(s), image capturing device(s), microphone(s), etc.) located in or mounted on various positions within or on the vehicle body. In such cases, the sensor device(s) may capture sensor data of the environment proximate the vehicle.

In some examples, the planning component may detect one or more relevant objects in the environment. The relevant object(s) may include any key feature, element, and/or region of the environment with information relevant for the driving task. For example, relevant object(s) may include traffic light(s), traffic signage, construction data (e.g., construction worker(s), construction signage, etc.), object data proximate the vehicle (e.g., object classification, object location, etc.), emergency vehicle(s), etc. In some examples, the planning component may detect the relevant object(s) by analyzing the sensor data. Additionally or alternatively, the planning component may use map data and/or the live sensor data to detect the relevant object(s). Map data may include a representation of the static (or fixed) feature(s), attribute(s), and/or object(s) in the environment. As such, the planning component may utilize the map data to identify object(s) which may be relevant such as traffic lights, traffic signs, etc. The map data may enable the vehicle to identify the relevant object(s) without the relevant object(s) being included in the live sensor data.

Additionally or alternatively, the planning component may determine a hierarchy or ranking of the relevant object(s). Such a rank or hierarchy may indicate a prioritization and/or importance of the relevant object(s). In some examples, the planning component may rank the relevant object(s) based on one or more factors such as the type of object (e.g., certain types of data may be more relevant or important than others), the path of the vehicle, environmental conditions (e.g., weather, time of day, etc.), etc. In some examples, the path of the vehicle may impact the ranking because certain object(s) may be more relevant than others based on the path. As an example, if the path indicates the vehicle is turning right, the traffic lights on the right may be more relevant than a construction worker further down the roadway.

In some examples, the planning component may detect one or more blocking features that may block the field of view of one or more sensor devices of the vehicle. A blocking feature may include a semi-truck, a bus, a trailer, a light source (e.g., glare, sunlight, vehicle headlights, etc.), particulate matter (e.g., dust, exhaust, fog, steam, etc.), etc. In some examples, the planning component may analyze the sensor data to detect the blocking feature(s). When detecting the blocking feature(s), the planning component determine data associated with such features such as location, heading, velocity, acceleration, steering angle, state, etc.

In some examples, the planning component generate one or more candidate actions. A candidate action may be a trajectory that includes a spatial representation of future movements of the vehicle in addition to one or more vehicle controls (e.g., velocity, acceleration, yaw, steering angle, etc.). That is, the candidate actions may include instructions that instruct the vehicle how to navigate a portion of the environment. The candidate actions can include instructions that cause the vehicle to perform one or more actions, such as remain in the same lane, lane change left, lane change right, pass an object proximate the vehicle, modify vehicle kinematics (e.g., velocity, acceleration, etc.), and/or any other type of action. In some examples, a candidate action may include multiple predicted states that can represent the state information of the vehicle at a specific location along the candidate action. State information may include location data, pose data (e.g., lateral offset data, longitudinal offset data, heading offset data), velocity data, acceleration data, and/or other types of data. Examples of various techniques for generating planner actions (or trajectories) for autonomous vehicles can be found, for example, in U.S. Pat. No. 10,921,811, filed on Jan. 22, 2018, issued on Feb. 16, 2021, and titled, “Adaptive Autonomous Vehicle Planner Logic,” in U.S. patent application Ser. No. 18/440,642, filed Dec. 14, 2023, and titled “Machine-Learned Cost Estimation in Tree Search Trajectory Generation for Vehicle Control,” in U.S. Pat. No. 11,875,678, filed on Jan. 21, 2021 and issued on Jan. 16, 2024, and titled “Unstructured Vehicle Path Planner,” and in U.S. Pat. No. 10,955,851, filed on Feb. 14, 2018, issued on Mar. 23, 2021, and titled, “Detecting Blocking Objects,” each of which is incorporated by reference herein in its entirety and for all purposes.

In some examples, the planning component may determine region(s) of the environment that are occluded based on the blocking features. A region may correspond to a physical area of the environment. An occluded region may be an area of the environment from which the sensor device(s) are unable to capture sensor data. In some examples, the planning component may determine the occluded regions by predicting where the blocking features may be located at a future time, where the vehicle may be located along the candidate action at the same future time, and/or determine an area of the environment that the is blocked from the field of view of the sensor devices. In some cases, the blocking object(s) may block at least a portion of the field of view of one or more of the sensor devices. The planning component my use the field of view and/or map data to determine the occluded regions. As such, in some examples, the planning component may determine separate occluded regions for individual sensor devices, a subset of sensor devices, or all sensor devices.

In some examples, the planning component may determine that at least a portion of the relevant object(s) (or the data associated with such object(s) (e.g., trajectory of the object, path of the object, etc.)) are located within the occluded region(s). That is, the planning component can determine whether the relevant object(s) are located within the occluded region(s). The relevant object(s) may be located within the occluded region if the position and/or dimension of the object is located within the bounds of the occluded region.

In some examples, the planning component may determine a cost of the candidate actions associated with the occluded region and/or the relevant object(s). The cost may indicate the quality of the action and/or the ability of the sensor device(s) to view the relevant object(s). In some examples, the cost may be determined based on one or more factors such as the number of sensor device(s) that can (or cannot) view (or capture sensor data of) the relevant object, the amount of the relevant object(s) that the sensor device(s) can view (or capture sensor data of), the ranking (or importance) of the relevant object, etc.

In some examples, the planning component may determine a candidate action for the vehicle to follow based on the cost values. For example, the planning component may identify the candidate action with the lowest overall cost (e.g., low being indicative of a high quality action) and control the vehicle based on the candidate action. Additionally or alternatively, the planning component my alter (or modify) the candidate action such that at least one sensor device is able to view the relevant object(s). For example, the planning component may predict a portion of the driving lane (within which the vehicle is located) that may optimize or improve the position of the sensor devices such that the sensor device(s) may be able to view the relevant object(s). As an example, the planning component may predict that at least one of the sensor device(s) may be able to capture data of the relevant object if the vehicle modifies the future vehicle position to left or right. In such cases, the planning component may generate a modified action that instructs the vehicle to navigate to the region. The modified vehicle action may be an entirely new action or a modified version of an already existing candidate action. The vehicle may be controlled based on the modified candidate action.

In some examples the candidate action may be a candidate trajectory for the vehicle to follow. Additionally or alternatively, the candidate action may include setting or adjusting a vertical height of the vehicle to increase the sensor device(s) ability to capture data of the relevant object. That is, the planning component may determine that increasing or decreasing the height of the vehicle by a particular amount may allow the vehicle to capture data of the relevant object. As such, the vehicle may be controlled to adjust a suspension of the vehicle to the modified vertical height. Additional examples of modifying vehicle suspension to modify a field of view of the sensors may be found in at least U.S. Pat. No. 10,688,841, issued on Jun. 23, 2020, and titled, “Expanding Sensor Domain Coverage Using Differential Active Suspension,” each of which is incorporated by reference herein in its entirety and for all purposes.

Additionally or alternatively, the planning component may determine a modified route to the destination based on a blocking feature (e.g., glare). That is, the planning component may determine that alternative route(s) may increase the ability of the sensor device(s) to capture quality sensor data. For example, the planning component may determine that there is a degradation in the quality of the sensor data (e.g., difficulty detecting blinker(s) of proximate vehicles (e.g., the intensity values of the sensor data are decreasing)). Based on the degradation of sensor data quality, the planning component may determine a location of the light source. In this case, the light source may be the sun, a reflection, headlights of a vehicle, etc. Further, the planning component may determine relative angle between the heading of the vehicle and the angle at which the light source is approaching the vehicle (e.g., angle of arrival between the light source location and the vehicle). In such cases, the planning component may determine, based on map data, the location of the light source, and/or the relative angle, a predicted driving lane (or road segment) that is shaded from, or otherwise undegraded by, the light source (e.g., a driving lane or other road segment in which sensor data is not degraded by the light source). In such cases, the planning component may determine a modified route that causes the vehicle to navigate to, or along, one or more of the shaded or undegraded driving lanes, thereby increasing the ability of the sensor device to capture sensor data of the relevant object(s).

Importantly, the techniques described herein may be used with respect to when the relevant object(s) are currently in occluded regions or when the relevant object(s) are predicted to be in occluded regions (e.g., the relevant object is currently visible but following a trajectory would cause the relevant objects to be occluded).

Additionally or alternatively, the techniques described above may be utilized for audio capturing sensors such as microphones. In such cases, the planning component may position (or generate modified trajectories) to optimize the capability of the audio device to capture quality audio data. That is, the planning component may modify the position of the vehicle within the environment such that the microphones can capture optimal audio data. For example, a vehicle may position the vehicle behind a blocking object such that the noise from a construction zone maybe blocked and/or mitigated, thereby increasing the quality of the captured audio data.

The techniques described herein can improve the functioning, safety, and efficiency of the autonomous and semi-autonomous vehicles operating in various driving environments. Positioning the vehicle in regions of the environment to improve sensor device utility may increase the ability of the vehicle to perform localization and/or vehicle planning operations. That is, the vehicle may use static objects within the environment to localize and/or determine a pose while the vehicle navigates an environment. As such, positioning the vehicle in improved locations may increase the ability of the sensor device(s) to capture data of static object(s), thereby increasing the ability of the vehicle to determine accurate and/or precise localization data.

The techniques described herein may be implemented in several ways. Example implementations are provided below with reference to the following figures. Although discussed in the context of an autonomous vehicle, the methods, apparatuses, and systems described herein may be applied to a variety of systems, and are not limited to autonomous vehicles. In another example, the techniques may be utilized in an aviation or nautical context, or in any other system. Additionally, the techniques described herein may be used with real data (e.g., captured using sensor(s)), simulated data (e.g., generated by a simulator), or any combination of the two.

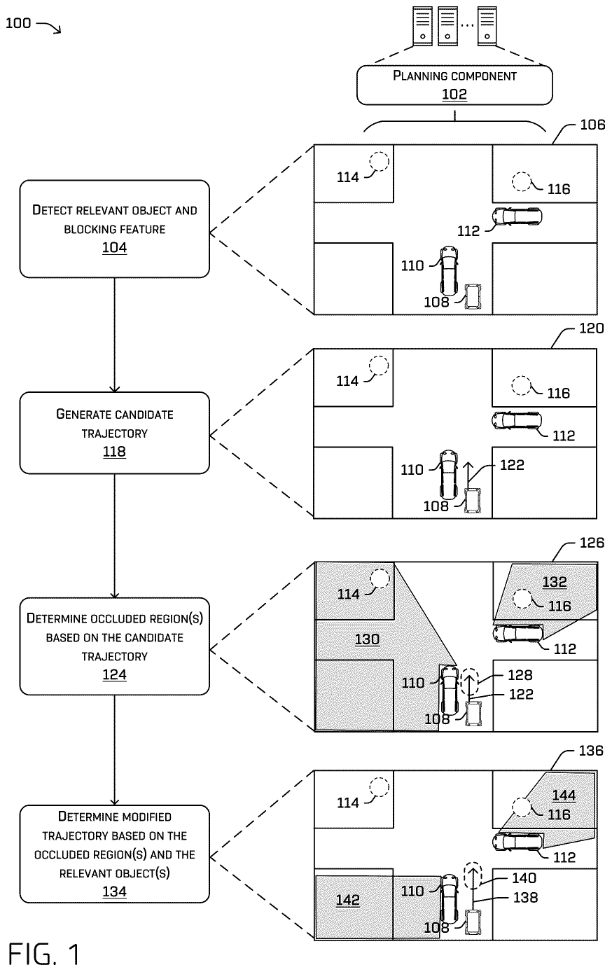

FIG. 1 is a pictorial flow diagram illustrating an example process 100 for improving sensor utility based on vehicle positioning. As shown in this example, some or all of the operations in the example process 100 may be performed by a perception component, a prediction component, a planning component 102, and/or any other component or systems remote from, or within, an autonomous vehicle.

At operation 104, the planning component 102 may detect relevant object(s) and blocking feature(s). In some examples, a vehicle may navigate an environment to a destination. The vehicle may capture sensor data of the environment from one or more sensor device(s). In some examples, the planning component 102 may analyze the sensor data to detect object(s) in the environment that may be relevant or important to localizing the vehicle and/or planning paths for the vehicle. Such object(s) may include buildings, trees, traffic signs, traffic lights, etc. Further, the planning component 102 may detect one or more features in the environment that may block the view of the relevant objects. Such features may be considered blocking features which may include busses, trains, trailers, semi-trucks, etc. For example, box 106 illustrates two blocking objects and two relevant objects. In this example, box 106 includes a vehicle 108 approaching a junction. As shown, the box 106 may also include a blocking object 110 and a blocking object 112 which may both be busses; however, in other examples, the blocking objects may be any other type of blocking feature or object. Further, box 106 may include a relevant object 114 and a relevant object 116. Such relevant objects are illustrated as dashed circles which may represent a sign, a tree, a building, a traffic light, etc. However, in other examples, such object(s) may be dynamic objects which may be located within or outside of the drivable region (or area).

At operation 118, the planning component 102 may generate candidate trajectories (which may be a candidate action). When navigating the environment, the planning component 102 may generate one or more candidate actions which may include candidate trajectories that instruct the vehicle 108 to navigate the environment according to a predetermined velocity, acceleration, pose, etc. For example, box 120 illustrates a candidate trajectory 122 which may instruct the vehicle to bias slightly left and behind the front of the blocking object 110. Of course, in other examples, the planning component 102 may generate more than one candidate trajectory which may instruct the vehicle 108 to perform a similar or different operation.

At operation 124, the planning component 102 may determine occluded region(s) based on the candidate trajectory. That is, the planning component 102 may determine which regions of the environment the blocking objects occlude from the view of the sensor devices of the vehicle 108. A region may be considered as occluded if the blocking object 110 or the blocking object 112 block the field of view of the sensor devices such that the sensor devices are unable to capture sensor data of that area. For example, box 126 illustrates determining occluded regions based on the blocking objects and/or the candidate trajectory. In this example, box 126 may include a future state 128 of the vehicle 108 based on the candidate trajectory 122. As shown, the planning component 102 may determine, from the position of the future state 128, which regions of the environment are occluded based on the blocking object 110 and which regions of the environment are occluded based on the blocking object 112. As shown, the planning component 102 may determine that the region 130 (e.g., shaded region) may be an occluded region based on the blocking object 110 and the region 132 may be an occluded region based on the blocking object 112. In this example, the relevant object 114 may be in the occluded region 130 and the relevant object 116 may be within the occluded region 132.

At operation 134, the planning component 102 may determine a modified trajectory based on the occluded regions and the relevant objects. That is, the planning component 102 may determine that the candidate trajectory 122 may be suboptimal due to the candidate trajectory 122 causing the vehicle 108 to be unable to view the relevant object. As such, the planning component 102 may predict a location within the driving lane that may increase the ability of the vehicle 108 to capture sensor data of the relevant objects. For example, box 136 illustrates a modified trajectory 138. As shown, box 136 includes the modified trajectory 138 which may cause the vehicle 108 to navigate to the right of the candidate trajectory 122 and further forward than the candidate trajectory 122. In other examples, the modified trajectory 138 may instruct the vehicle 108 to bias toward a side of the driving lane, modify the vehicle 108 lateral, longitudinal, and/or heading offsets within the lane, etc. The purpose of the modified trajectory 138 is to increase the ability of at least one sensor device (which may be located at various positions around or on the vehicle 108 body (e.g., on vehicle roof, on corners of the vehicle, etc.) to capture data of the relevant object(s). In another example, the modified trajectory would not have been selected had the at least one sensor device been able to capture data of the relevant object(s). That is—the modified trajectories are published, created, and/or selected because of the lack of sensing an object, object's trajectory, or object's future state. In other words the desire to gain or keep a detection of a sensed object, object's trajectory, or object's future state is accounted for by a planner to modify a candidate trajectory, publish a candidate trajectory that it would have otherwise not published, or selected a candidate trajectory, of a list of candidate trajectories, that it would have otherwise not selected. As such, the planning component 102 may determine updated occluded regions which may include the occluded region 142 and the occluded region 144. As shown, the relevant object 114 may be outside of the occluded regions and the relevant object 116 may be at least partially outside of the occluded region 144. As such, the planning component 102 may cause the vehicle to follow the modified trajectory 138 of a plurality of trajectories to choose from.

Though it has been described that the planning component 102 may cause the vehicle to follow the modified trajectory, in other examples, the planning component 102 may cause one or more vehicle systems to connect with (or send data to) one or more remote operating systems. That is, based on data captured from the modified trajectory, the planning component 102 may request assistance (or instruction) from a remote operator as to how to navigate a portion of the environment.

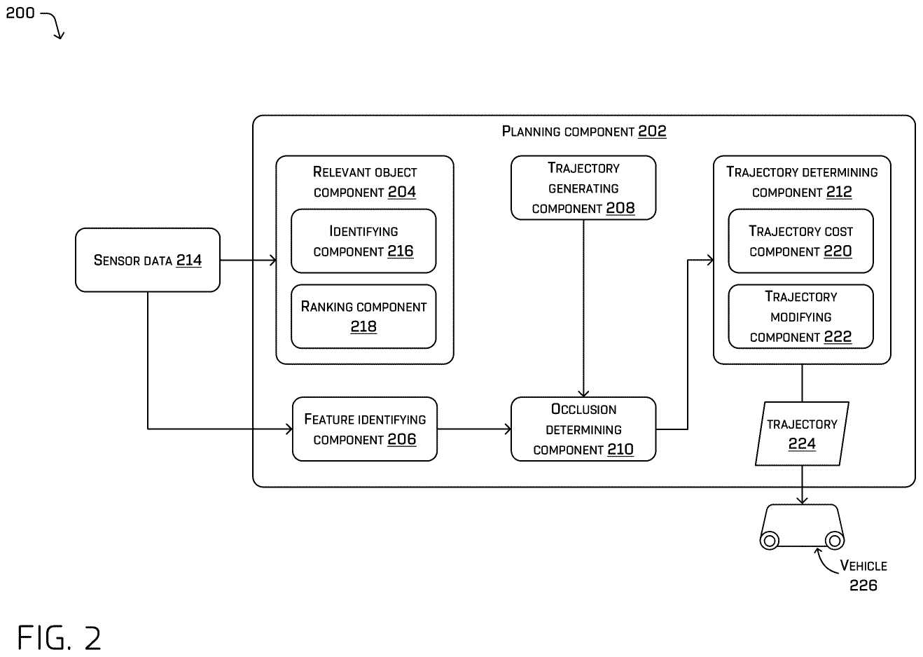

FIG. 2 illustrates an example computing system 200 including a planning component 202 configured to determine improved positions in an environment for a vehicle to increase the quality and/or utility of captured sensor data.

In some examples, the planning component 202 may include various components, described below, configured to perform different functionalities of improving vehicle positioning within an environment. In some examples, some or all subcomponents of the planning component 202 may be integrated in a remote system and/or in any on-vehicle system. In some examples, the planning component 202 may include a relevant object component 204 configured to determine relevant object(s) within the environment, a feature component 206 configured to determine blocking feature(s) within the environment, a trajectory generating component 208 configured to generate candidate trajectories, an occlusion determining component 210 configured to determine occlusions within the environment, and/or a trajectory determining component 212 configured to determine a trajectory for the vehicle to follow.

In some examples, the planning component 202 may receive sensor data 214 from one or more sensor devices mounted on or located within any portion of the vehicle 226. The sensor device(s) may include lidar devices, radar devices, image capturing devices, infrared devices, time-of-flight devices, and/or any other type of device. In some examples, the sensor device(s) may be configured to capture sensor data 214 of the environment while the vehicle traverses the environment. As shown, the relevant object component 204 may receive the sensor data 214.

In some examples, the planning component 202 may include a relevant object component 204 configured to determine relevant object(s) within the environment. As shown, the relevant object component 204 may receive the sensor data 214. The relevant object component 204 may be configured to analyze the sensor data 214 to detect and/or rank the relevant object(s) in the environment. As shown, the relevant object component 204 may include one or more subcomponents such as the identifying component 216 and the ranking component 218. The identifying component 216 may be configured to analyze the sensor data 214 to identify or otherwise detect object(s) in the environment that may be relevant to the vehicle 226. The ranking component 218 may be configured to rank the relevant objects in order of importance and/or relevance. The ranking component 218 may determine the ranking based on the object classification (e.g., certain classifications may be more important or relevant than others), the path of vehicle (e.g., certain object(s) may be more important based on being located closer to, or along, the path), environmental condition(s), etc.

In some examples, the planning component 202 may include a feature component 206 configured to determine blocking feature(s) or degrading features within the environment. As shown, the feature component 206 may receive the sensor data 214. The feature component 206 may analyze the sensor data 214 to determine whether the environment includes object(s) which may block the field of view of the sensor device(s) of the vehicle. Such object(s) may include busses, semi-trucks, trailers, particulate matter, etc. Further, the feature component 206 may detect other features which may block portions of the field of view of the sensor devices such as glares, headlights of other vehicles, etc.

In some examples, the planning component 202 may include a trajectory generating component 208 configured to generate candidate trajectories. The trajectory generating component 208 may receive sensor data 214 (not shown) indicative of the current driving scenario. The trajectory generating component 208 may use such sensor data to generate candidate actions (or trajectories) through the environment. As shown, the trajectory generating component 208 may send candidate action data to the occlusion determining component 210.

In some examples, the planning component 202 may include an occlusion determining component 210 configured to determine occlusions within the environment. The occlusion determining component 210 may analyze the candidate trajectories and/or the blocking features to determine the presence, locations, and/or dimensions (or bounds) of occlusions proximate the vehicle. That is, the occlusion determining component 210 may use the candidate trajectory to predict where the vehicle may be located at a future time, predict where the object(s) may be located at the same future time, and determine the occlusions based on such data. In some cases, the occlusion determining component 210 may determine the occlusions at each timestep for some or all sensor devices of the vehicle. For instance, the occlusion determining component 210 may determine separate occlusions for a first sensor device located at the front of the vehicle and a separate occlusion for a second sensor device at the back of the vehicle. In some cases, the occlusion determining component 210 may send the occlusion data to the trajectory determining component 212.

In some examples, the planning component 202 may include a trajectory determining component 212 configured to determine a trajectory for the vehicle to follow. That is, the trajectory determining component 212 may analyze the occlusions, the relevant object(s), and/or the blocking features to determine an improved position for the vehicle 226 in the environment to improve the amount and/or quality of data that at least one sensor device of the vehicle 226 can capture of the relevant object(s). As shown, the trajectory determining component 212 may include subcomponents such as the trajectory cost component 220 and the trajectory modifying component 222. The trajectory cost component 220 may be configured to determine a cost for following the trajectory based on a variety of factors. Such factors may include a number of the sensor device(s) that can capture data of the relevant object, an amount of the relevant object that is occluded, a ranking of the relevant object, etc. In some examples, the trajectory determining component 212 may determine that the vehicle 226 may follow the trajectory with the lowest cost value. The trajectory determining component 212 may send the trajectory 224 to the vehicle 226 such that the vehicle 226 may follow the trajectory 224.

Additionally or alternatively, the trajectory modifying component 222 may be configured to modify the vehicle trajectory based on the vehicle being (or predicted to be) in a suboptimal position. For example, the trajectory modifying component 222 may predict that an area of the driving lane may increase the amount and/or quality of sensor data captured of the relevant object. As such, the trajectory modifying component 222 may generate a modified trajectory that causes the vehicle 226 to navigate to that area. In such cases, the trajectory determining component 212 may send the modified trajectory to the vehicle 226 such that the vehicle 226 may follow the trajectory.

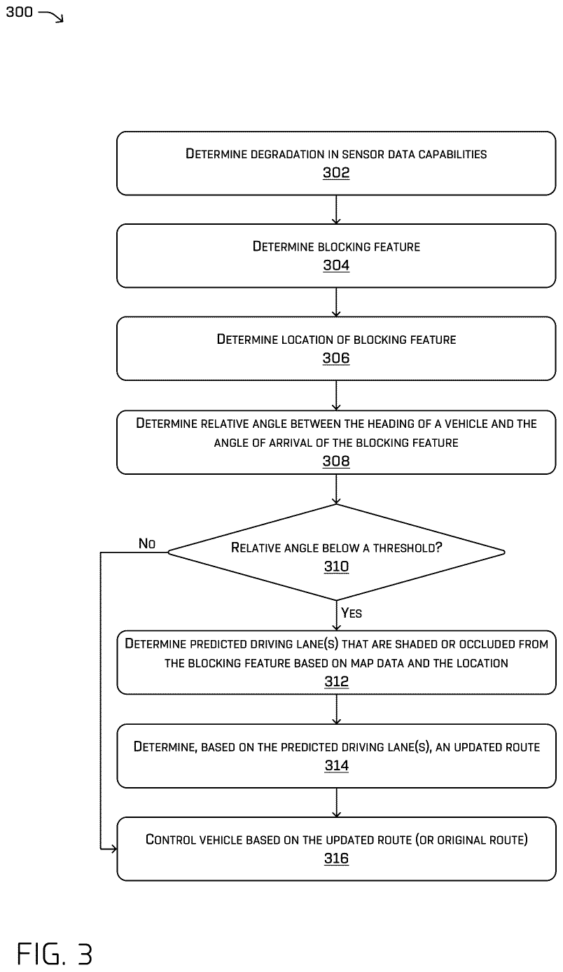

FIG. 3 is a flow diagram illustrating an example process 300 for modifying a vehicle route based on a degradation in sensor data quality and/or capabilities. As described below, the process 300 may be performed by one or more computer-based components configured to implement various functionalities described herein. For instance, some or all of the operations of process 300 may be performed by a planning component 202. As described above, planning component 202 may be integrated as an on-vehicle system in some examples. However, in other examples, the planning component 202 may be integrated as a separate server-based system.

Process 300 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 302, the planning component 202 may determine degradation in sensor data capabilities. In some examples, the planning component 202 may determine the degradation in sensor data based on a difficulty in detecting object(s) proximate the vehicle. For example, the planning component 202 may determine that the intensity values of the sensor data are decreasing. As such, the planning component 202 may determine that the sensor data quality and/or the sensor device capabilities are being degraded.

At operation 304, the planning component 202 may determine a blocking feature in the environment. In this example, a blocking feature may include a light source (e.g., glare, sunlight, vehicle headlights, etc.), etc. In some examples, the planning component may analyze the sensor data to detect the blocking feature(s).

At operation 306, the planning component 202 may determine a location of the blocking feature. The planning component 202 may utilize the sensor data, environmental data (e.g., weather data, time of day data, etc.), etc. to determine the location of the light source. That is, the planning component 202 may utilize such data to determine or predict where the sun or the headlights are located.

At operation 308, the planning component 202 may determine a relative angle between the heading of the vehicle and the angle of arrival of the blocking feature. In some examples, the planning component 202 may determine a relative angle between the light source and the vehicle. That is, in some cases, the sensor data may degrade when the light source is shining directly (or nearly directly) into the sensor device. As such, the planning component 202 may determine an angle of arrival of the light from the light source, a heading of the vehicle, and determine a relative angle between the angle of arrival and the heading.

At operation 310, the planning component 202 may determine whether the relative angle is below a threshold. That is, if the relative angle meets or exceeds a threshold, the planning component 202 may determine that the light source may not significantly impact the driving capabilities. As such, if the relative angle meets or exceeds a threshold value (310:No), the planning component 202 may control the vehicle based on the original path or route.

In contrast, if the relative angle is below the threshold (310:Yes), the planning component 202 may determine alternative lanes that are shaded from, or otherwise undegraded by, the light source. That is, at operation 312, the planning component 202 may determine predicted driving lane(s) that are shaded from the blocking feature based on map data and the location. The planning component 202 may identify such driving lanes based on the location of the light source, the angle at which the light from the light source is arriving, the height of surrounding buildings (or trees), etc.

At operation 314, the planning component 202 may determine, based on the predicted driving lane(s), an updated route. Based on identifying roadways that are predicted to be shaded or occluded from the light source, the planning component 202 may determine a new route that causes the vehicle to deviate from the original route. The new route may cause the vehicle to navigate to the driving lanes that are shaded.

At operation 316, the planning component 202 may control the vehicle based on the updated route (or original route). That is, the planning component 202 may control the vehicle based on the new route determined at operation 314. In such cases, the planning component 202 may perform vehicle operations based on the new route.

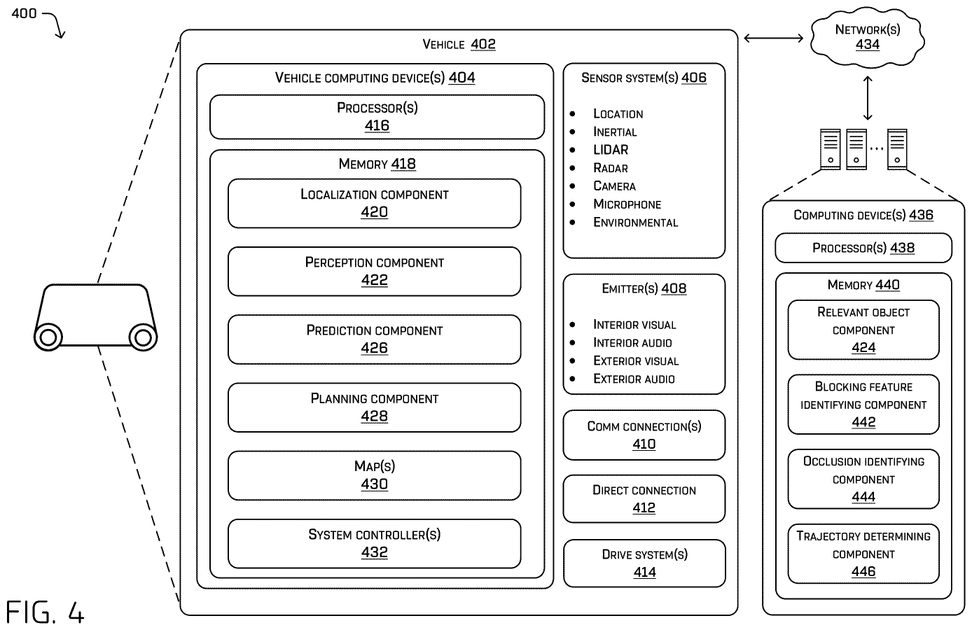

FIG. 4 is a block diagram of an example system 400 for implementing the techniques described herein. In at least one example, the system 400 may include a vehicle, such as vehicle 402. The vehicle 402 may include one or more vehicle computing devices 404, one or more sensor systems 406, one or more emitters 408, one or more communication connections 410, at least one direct connection 412, and one or more drive systems 414.

The vehicle computing device 404 may include one or more processors 416 and memory 418 communicatively coupled with the processor(s) 416. In the illustrated example, the vehicle 402 is an autonomous vehicle; however, the vehicle 402 could be any other type of vehicle, such as a semi-autonomous vehicle, or any other system having at least an image capture device (e.g., a camera-enabled smartphone). In some instances, the autonomous vehicle 402 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the autonomous vehicle 402 may be a fully or partially autonomous vehicle having any other level or classification.

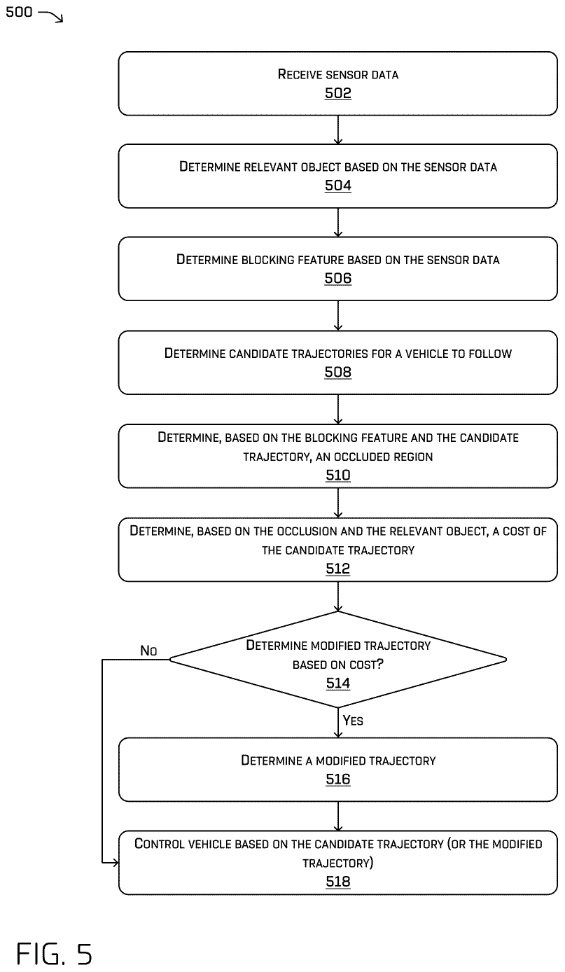

In the illustrated example, the memory 418 of the vehicle computing device 404 stores a localization component 420, a perception component 422, a prediction component 426, a planner component 428, one or more system controllers 432, and one or more maps 430 (or map data). Though depicted in FIG. 5 as residing in the memory 418 for illustrative purposes, it is contemplated that the localization component 420, the perception component 422, the prediction component 426, the planner component 428, system controller(s) 432, and/or the map(s) may additionally, or alternatively, be accessible to the vehicle 402 (e.g., stored on, or otherwise accessible by, memory remote from the vehicle 402, such as, for example, on memory 440 of one or more computing device 436). In some examples, the memory 440 may include a relevant object component 424, a blocking feature identifying component 442, an occlusion identifying component 444, and/or a trajectory determining component 446.

In at least one example, the localization component 420 may include functionality to receive sensor data from the sensor system(s) 406 to determine a position and/or orientation of the vehicle 402 (e.g., one or more of an x-, y-, z-position, roll, pitch, or yaw). For example, the localization component 420 may include and/or request/receive a map of an environment, such as from map(s) 430, and may continuously determine a location and/or orientation of the vehicle 402 within the environment. In some instances, the localization component 420 may utilize SLAM (simultaneous localization and mapping), CLAMS (calibration, localization and mapping, simultaneously), relative SLAM, bundle adjustment, non-linear least squares optimization, or the like to receive image data, lidar data, radar data, inertial measurement unit (IMU) data, GPS data, wheel encoder data, and the like to accurately determine a location of the vehicle 402. In some instances, the localization component 420 may provide data to various components of the vehicle 402 to determine an initial position of the vehicle 402 for determining the relevance of an object to the vehicle 402, as discussed herein.

In some instances, the perception component 422 may include functionality to perform object detection, segmentation, and/or classification. In some examples, the perception component 422 may provide processed sensor data that indicates a presence of an object (e.g., entity) that is proximate to the vehicle 402 and/or a classification of the object as an object type (e.g., car, pedestrian, cyclist, animal, building, tree, road surface, curb, sidewalk, unknown, etc.). In some examples, the perception component 422 may provide processed sensor data that indicates a presence of a stationary entity that is proximate to the vehicle 402 and/or a classification of the stationary entity as a type (e.g., building, tree, road surface, curb, sidewalk, unknown, etc.). In additional or alternative examples, the perception component 422 may provide processed sensor data that indicates one or more features associated with a detected object (e.g., a tracked object) and/or the environment in which the object is positioned. In some examples, features associated with an object may include, but are not limited to, an x-position (global and/or local position), a y-position (global and/or local position), a z-position (global and/or local position), an orientation (e.g., a roll, pitch, yaw), an object type (e.g., a classification), a velocity of the object, an acceleration of the object, an extent of the object (size), etc. Features associated with the environment may include, but are not limited to, a presence of another object in the environment, a state of another object in the environment, a time of day, a day of a week, a season, a weather condition, an indication of darkness/light, etc.

The prediction component 426 may generate one or more probability maps representing prediction probabilities of possible locations of one or more objects in an environment. For example, the prediction component 426 may generate one or more probability maps for vehicles, pedestrians, animals, and the like within a threshold distance from the vehicle 402. In some instances, the prediction component 426 may measure a track of an object and generate a discretized prediction probability map, a heat map, a probability distribution, a discretized probability distribution, and/or a trajectory for the object based on observed and predicted behavior. In some instances, the one or more probability maps may represent an intent of the one or more objects in the environment.

In some examples, the prediction component 426 may generate predicted trajectories of objects (e.g., objects) in an environment. For example, the prediction component 426 may generate one or more predicted trajectories for objects within a threshold distance from the vehicle 402. In some examples, the prediction component 426 may measure a trace of an object and generate a trajectory for the object based on observed and predicted behavior.

In general, the planner component 428 may determine a path for the vehicle 402 to follow to traverse through an environment. For example, the planner component 428 may determine various routes and trajectories and various levels of detail. For example, the planner component 428 may determine a route to travel from a first location (e.g., a current location) to a second location (e.g., a target location). For the purpose of this discussion, a route may include a sequence of waypoints for travelling between two locations. As non-limiting examples, waypoints include streets, intersections, global positioning system (GPS) coordinates, etc. Further, the planner component 428 may generate an instruction for guiding the vehicle 402 along at least a portion of the route from the first location to the second location. In at least one example, the planner component 428 may determine how to guide the vehicle 402 from a first waypoint in the sequence of waypoints to a second waypoint in the sequence of waypoints. In some examples, the instruction may be a candidate trajectory, or a portion of a trajectory. In some examples, multiple trajectories may be substantially simultaneously generated (e.g., within technical tolerances) in accordance with a receding horizon technique. A single path of the multiple paths in a receding data horizon having the highest confidence level may be selected to operate the vehicle. In various examples, the planner component 428 may select a trajectory for the vehicle 402.

In other examples, the planner component 428 may alternatively, or additionally, use data from the localization component 420, the perception component 422, and/or the prediction component 426 to determine a path for the vehicle 402 to follow to traverse through an environment. For example, the planner component 428 may receive data (e.g., object data) from the localization component 420, the perception component 422, and/or the prediction component 426 regarding objects associated with an environment. In some examples, the planner component 428 receives data for relevant objects within the environment. Using this data, the planner component 428 may determine a route to travel from a first location (e.g., a current location) to a second location (e.g., a target location) to avoid objects in an environment. In at least some examples, such a planner component 428 may determine there is no such collision-free path and, in turn, provide a path that brings vehicle 402 to a safe stop avoiding all collisions and/or otherwise mitigating damage. Further, the planning component 428 may perform any of the techniques described above with respect to any of FIGS. 1-3 with respect to improving vehicle positioning to increase sensor utility.

In at least one example, the vehicle computing device 404 may include one or more system controllers 432, which may be configured to control steering, propulsion, braking, safety, emitters, communication, and other systems of the vehicle 402. The system controller(s) 432 may communicate with and/or control corresponding systems of the drive system(s) 414 and/or other components of the vehicle 402.

The memory 418 may further include one or more maps 430 that may be used by the vehicle 402 to navigate within the environment. For the purpose of this discussion, a map may be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map may include a three-dimensional mesh of the environment. In some examples, the vehicle 402 may be controlled based at least in part on the map(s) 430. That is, the map(s) 430 may be used in connection with the localization component 420, the perception component 422, the prediction component 426, and/or the planner component 428 to determine a location of the vehicle 402, detect objects in an environment, generate routes, determine actions and/or trajectories to navigate within an environment.

In some examples, the one or more maps 430 may be stored on a remote computing device(s) (such as the computing device(s) 436) accessible via network(s) 434. In some examples, multiple maps 430 may be stored based on, for example, a characteristic (e.g., type of entity, time of day, day of week, season of the year, etc.). Storing multiple maps 430 may have similar memory requirements, but increase the speed at which data in a map may be accessed.

In some instances, aspects of some or all of the components discussed herein may include any models, techniques, and/or machine-learned techniques. For example, in some instances, the components in the memory 418 (and the memory 440, discussed below) may be implemented as a neural network.

As described herein, an exemplary neural network is a technique which passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID 3), Chi-squared automatic interaction detection (CHAID), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

Additional examples of architectures include neural networks such as ResNet-50, ResNet-101, VGG, DenseNet, PointNet, Xception, ConvNeXt, and the like; visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. patent application Ser. No. 15/963,833 , which is incorporated by reference in its entirety herein for all purposes), and/or VoxelNet. Architecture latency optimizations may include MobilenetV2, Shufflenet, Channelnet, Peleenet, and/or the like. The ML model may comprise a residual block such as Pixor, in some examples.

In at least one example, the sensor system(s) 406 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), etc. The sensor system(s) 406 may include multiple instances of each of these or other types of sensors. For instance, the lidar sensors may include individual lidar sensors located at the corners, front, back, sides, and/or top of the vehicle 402. As another example, the camera sensors may include multiple cameras disposed at various locations about the exterior and/or interior of the vehicle 402. The sensor system(s) 406 may provide input to the vehicle computing device 404. Additionally, or in the alternative, the sensor system(s) 406 may send sensor data, via the one or more networks 434, to the one or more computing device(s) 436 at a particular frequency, after a lapse of a predetermined period of time, in near real-time, etc.

The vehicle 402 may also include one or more emitters 408 for emitting light and/or sound. The emitter(s) 408 may include interior audio and visual emitters to communicate with passengers of the vehicle 402. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 408 may also include exterior emitters. By way of example and not limitation, the exterior emitters may include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 402 may also include one or more communication connections 410 that enable communication between the vehicle 402 and one or more other local or remote computing device(s). For instance, the communication connection(s) 410 may facilitate communication with other local computing device(s) on the vehicle 402 and/or the drive system(s) 414. Also, the communication connection(s) 410 may allow the vehicle to communicate with other nearby computing device(s) (e.g., computing device 436, other nearby vehicles, etc.) and/or one or more remote sensor system(s) for receiving sensor data. The communications connection(s) 410 also enable the vehicle 402 to communicate with a remote teleoperations computing device or other remote services.

The communications connection(s) 410 may include physical and/or logical interfaces for connecting the vehicle computing device 404 to another computing device or a network, such as network(s) 434. For example, the communications connection(s) 410 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

In at least one example, the vehicle 402 may include one or more drive systems 414. In some examples, the vehicle 402 may have a single drive system 414. In at least one example, if the vehicle 402 has multiple drive systems 414, individual drive systems 414 may be positioned on opposite ends of the vehicle 402 (e.g., the front and the rear, etc.). In at least one example, the drive system(s) 414 may include one or more sensor systems to detect conditions of the drive system(s) 414 and/or the surroundings of the vehicle 402. By way of example and not limitation, the sensor system(s) may include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, lidar sensors, radar sensors, etc. Some sensors, such as the wheel encoders may be unique to the drive system(s) 414. In some cases, the sensor system(s) on the drive system(s) 414 may overlap or supplement corresponding systems of the vehicle 402 (e.g., sensor system(s) 406).

The drive system(s) 414 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 414 may include a drive module controller which may receive and preprocess data from the sensor system(s) and to control operation of the various vehicle systems. In some examples, the drive module controller may include one or more processors and memory communicatively coupled with the one or more processors. The memory may store one or more modules to perform various functionalities of the drive system(s) 414. Furthermore, the drive system(s) 414 may also include one or more communication connection(s) that enable communication by the respective drive module with one or more other local or remote computing device(s).

In at least one example, the direct connection 412 may provide a physical interface to couple the one or more drive system(s) 414 with the body of the vehicle 402. For example, the direct connection 412 may allow the transfer of energy, fluids, air, data, etc. between the drive system(s) 414 and the vehicle. In some instances, the direct connection 412 may further releasably secure the drive system(s) 414 to the body of the vehicle 402.

In at least one example, the localization component 420, the perception component 422, the prediction component 426, the planner component 428, the one or more system controllers 432, and the one or more maps 430 may process sensor data, as described above, and may send their respective outputs, over the one or more network(s) 434, to the computing device(s) 436. In at least one example, the localization component 420, the perception component 422, the prediction component 426, the planner component 428, the one or more system controllers 432, and the one or more maps 430 may send their respective outputs to the computing device(s) 436 at a particular frequency, after a lapse of a predetermined period of time, in near real-time, etc.

In some examples, the vehicle 402 may send sensor data to the computing device(s) 436 via the network(s) 434. In some examples, the vehicle 402 may receive sensor data from the computing device(s) 436 and/or remote sensor system(s) via the network(s) 434. The sensor data may include raw sensor data and/or processed sensor data and/or representations of sensor data. In some examples, the sensor data (raw or processed) may be sent and/or received as one or more log files.

The computing device(s) 436 may include processor(s) 438 and a memory 440, which may include relevant object component 424, a blocking feature identifying component 442, an occlusion identifying component 444, and/or a trajectory determining component 446. In some examples, the memory 440 may store one or more of components that are similar to the component(s) stored in the memory 418 of the vehicle 402. In such examples, the computing device(s) 436 may be configured to perform one or more of the processes described herein with respect to the vehicle 402. In some examples, the relevant object component 424, the blocking feature identifying component 442, the occlusion identifying component 444, and/or the trajectory determining component 446 may perform substantially similar functions as the planning component 428.

The processor(s) 416 of the vehicle 402 and the processor(s) 438 of the computing device(s) 436 may be any suitable processor capable of executing instructions to process data and perform operations as described herein. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 418 and memory 440 are examples of non-transitory computer-readable media. The memory 418 and memory 440 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

It should be noted that while FIG. 4 is illustrated as a distributed system, in alternative examples, components of the vehicle 402 may be associated with the computing device(s) 436 and/or components of the computing device(s) 436 may be associated with the vehicle 402. That is, the vehicle 402 may perform one or more of the functions associated with the computing device(s) 436, and vice versa. The methods described herein represent sequences of operations that may be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes. In some examples, one or more operations of the method may be omitted entirely. For instance, the operations may include determining a first action and a second action by the vehicle relative to a selected trajectory without determining a respective cost for one or more of the actions by the vehicle. Moreover, the methods described herein may be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

FIG. 5 is a flow diagram illustrating an example process 500 for detecting relevant object(s) and blocking object(s), generating a candidate trajectory, determining occluded region(s) based on the blocking object(s) and the candidate trajectory, and determining a modified trajectory based on the occluded region(s) and the relevant object(s). As described below, the process 500 may be performed by one or more computer-based components configured to implement various functionalities described herein. For instance, some or all of the operations of process 500 may be performed by a planning component 202. As described above, planning component 202 may be integrated as an on-vehicle system in some examples. However, in other examples, the planning component 202 may be integrated as a separate server-based system.

Process 500 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 502, the planning component 202 may receive sensor data. That is, the vehicle may capture sensor data while navigating an environment. The vehicle may include one or more sensor device(s) (e.g., lidar device(s), radar device(s), time-of-flight device(s), image capturing device(s), etc.) located in or mounted on various positions within or on the vehicle body. In such cases, the sensor device(s) may capture sensor data of the environment proximate the vehicle.

At operation 504, the planning component 202 may determine relevant object(s) based on the sensor data. The relevant object(s) may include any key feature, element, and/or region of the environment with information relevant for the driving task. For example, relevant object(s) may include traffic light(s), traffic signage, construction data (e.g., construction worker(s), construction signage, etc.), object data proximate the vehicle (e.g., object classification, object location, etc.), emergency vehicle(s), etc. In some examples, the planning component may detect the relevant object(s) by analyzing the sensor data. Additionally or alternatively, the planning component may use map data and/or the live sensor data to detect the relevant object(s). Map data may include a representation of the static (or fixed) feature(s), attribute(s), and/or object(s) in the environment. As such, the planning component may utilize the map data to identify object(s) which may be relevant such as the traffic lights, traffic signs, etc. The map data may enable the vehicle to identify the relevant object(s) without the relevant object(s) being included in the live sensor data.

Additionally or alternatively, the planning component may determine a hierarchy or ranking of the relevant object(s). Such a rank or hierarchy may indicate a prioritization and/or importance of the relevant object(s). In some examples, the planning component may rank the relevant object(s) based on one or more factors such as the type of object (e.g., certain types of data may be more relevant or important than others), the path of the vehicle, environmental conditions (e.g., weather, time of day, etc.), etc. In some examples, the path of the vehicle may impact the ranking because certain object(s) may be more relevant than others based on the path. As an example, if the path indicates the vehicle is turning right, the traffic lights on the right may be more relevant than a construction worker further down the roadway.

At operation 506, the planning component 202 may determine blocking feature(s) based on the sensor data. A blocking feature may include a semi-truck, a bus, a trailer, a light source (e.g., glare, sunlight, vehicle headlights, etc.), particulate matter (e.g., dust, exhaust, fog, steam, etc.), etc. In some examples, the planning component may analyze the sensor data to detect the blocking feature(s). When detecting the blocking feature(s), the planning component determine data associated with such features such as location, heading, velocity, acceleration, steering angle, state, etc.

At operation 508, the planning component 202 may determine candidate trajectories for the vehicle to follow. A candidate action may be a trajectory that includes a spatial representation of future movements of the vehicle in addition to one or more vehicle controls (e.g., velocity, acceleration, yaw, steering angle, etc.). That is, the candidate actions may include instructions that instruct the vehicle how to navigate a portion of the environment. The candidate actions can include instructions that cause the vehicle to perform one or more actions, such as remain in the same lane, lane change left, lane change right, pass an object proximate the vehicle, modify vehicle kinematics (e.g., velocity, acceleration, etc.), and/or any other type of action. In some examples, a candidate action may include multiple predicted states that can represent the state information of the vehicle at a specific location along the candidate action. State information may include location data, pose data (e.g., lateral offset data, longitudinal offset data, heading offset data), velocity data, acceleration data, and/or other types of data.

At operation 510, the planning component 202 may determine, based on the blocking feature(s) and the candidate trajectory, an occluded region. A region may correspond to a physical area of the environment. An occluded region may be an area of the environment from which the sensor device(s) are unable to capture sensor data. In some examples, the planning component may determine the occluded regions by predicting where the blocking features may be located at a future time, where the vehicle may be located along the candidate trajectory at the same future time, and/or determine an area of the environment that the is blocked from the field of view of the sensor devices. In some cases, the blocking object(s) may block at least a portion of the field of view of the sensor devices. The planning component my use the field of view and/or map data to determine the occluded regions. As such, in some examples, the planning component may determine separate occluded regions for some or all sensor devices.

At operation 512, the planning component 202 may determine, based on the occluded region and the relevant object(s), a cost of the candidate trajectory. The cost may indicate the quality of the trajectory and/or the ability of the sensor device(s) to view the relevant object(s). In some examples, the cost may be determined based on one or more factors such as the number of sensor device(s) that are can (or cannot) view (or capture sensor data of) the relevant object, the amount of the relevant object(s) that the sensor device(s) can view (or capture sensor data of), the ranking of the relevant object, etc.

At operation 514, the planning component 202 may determine whether to generate a modified trajectory based on the cost. In some examples, the planning component 202 may generate a modified trajectory if the cost values meet or exceed a threshold level (e.g., none of the candidate actions are sufficient). As such, if a modified trajectory is not needed (514:No), the planning component may control the vehicle based on the candidate trajectory. That is, the planning component may select the candidate trajectory with the lowest cost value and cause the vehicle to be controlled based on the candidate trajectory.

In contrast, if a modified trajectory is needed (514:Yes), the planning component may determine a modified trajectory. That is, at operation 516, the planning component 202 may generate a modified trajectory. For example, the planning component may predict a portion of the driving lane (within which the vehicle is located) that may optimize the position of the sensor devices such that the sensor device(s) may be able to view the relevant object(s). As an example, the planning component may predict that at least one of the sensor device(s) may be able to capture data of the relevant object if the vehicle modifies the future vehicle position to left or right. In such cases, the planning component may generate a modified trajectory that instructs the vehicle to navigate to the region. The modified vehicle trajectory may be an entirely new trajectory or a modified version of an already existing candidate action.

At operation 518, the planning component 202 may control the vehicle based on the trajectory (or the modified trajectory). As noted above, the vehicle may be controlled based on the modified candidate trajectory determined at operation 516 or the candidate trajectory.

### EXAMPLE CLAUSES

A: A system comprising: one or more processors; and one or more non-transitory computer-readable media storing computer-executable instructions that, when executed, cause the system to perform operations comprising: receiving, from a sensor device associated with a vehicle, sensor data of an environment; determining, based at least in part on the sensor data, a relevant object in the environment; determining, based at least in part on the sensor data, a blocking feature of the environment; generating a candidate trajectory for the vehicle to follow; determining, based at least in part on the blocking feature and the candidate trajectory, an occluded region within the environment; determining that the occluded region includes at least a portion of the relevant object; determining, based at least in part on the portion of the relevant object being in the occluded region, a cost associated with the candidate trajectory; determining, based at least in part on the cost and the candidate trajectory, a modified trajectory to increase an ability of the sensor device to capture data of the relevant object; and controlling the vehicle based at least in part on the modified trajectory.

B: The system of paragraph A, wherein determining the modified trajectory comprises: determining a degradation in quality of data captured by the sensor device; determining a location of a light source; determining a relative angle between the light source and a heading of the vehicle; determining, based at least in part on map data, the location, and a relative heading, a predicted driving lane that is shaded or occluded from the light source; and determining, based at least in part on the predicted driving lane, the modified trajectory.

C: The system of paragraph A, wherein determining the modified trajectory comprises: determining, for a future time and based at least in part on the blocking feature, the candidate trajectory, and the relevant object, a portion of a driving lane that causes the relevant object to be within a field of view of the sensor device; generating the modified trajectory that instructs the vehicle to navigate to the portion of the driving lane; and controlling the vehicle based at least in part on the modified trajectory.

D: The system of paragraph A, wherein determining the cost is based at least in part on at least one of: a number of sensor devices of the vehicle that have a field of view including the relevant object, a capability of the sensor device to capture second data of the relevant object, an amount of the relevant object that is within the field of view of the sensor device, or a ranking of the relevant object.

E: The system of paragraph A, wherein the blocking feature is at least one of: a second vehicle, a trailer, particulate matter, or light.

F: One or more non-transitory computer-readable media storing instructions executable by one or more processors, wherein the instructions, when executed, cause a system to perform operations comprising: receiving sensor data; determining, based at least in part on the sensor data, an object in an environment; determining, based at least in part on the sensor data, a feature of the environment; generating a candidate trajectory for a vehicle to follow; determining, based at least in part on the feature and the candidate trajectory, an occluded region within the environment; determining that the occluded region includes at least a portion of the object or a path of the object; determining, based at least in part on the portion of the object being in the occluded region, a modified trajectory to increase an ability of a sensor device to capture data of the object; and controlling the vehicle based at least in part on the modified trajectory.

G: The one or more non-transitory computer-readable media of paragraph F, wherein determining the modified trajectory comprises: determining a degradation in quality of data captured by the sensor device; determining a location of a light source; determining a relative angle between the light source and a heading of the vehicle; determining, based at least in part on map data, the location, and a relative heading, a predicted driving lane that is shaded or occluded from the light source; and determining, based at least in part on the predicted driving lane, the modified trajectory.

H: The one or more non-transitory computer-readable media of paragraph F, wherein determining the modified trajectory comprises: determining, for a future time and based at least in part on the feature, the candidate trajectory, and the object, a portion of a driving lane that causes the object to be within a field of view of the sensor device; generating the modified trajectory that instructs the vehicle to navigate to the portion of the driving lane; and controlling the vehicle based at least in part on the modified trajectory.

I: The one or more non-transitory computer-readable media of paragraph F, wherein determining the modified trajectory is based at least in part on: determining, based at least in part on the portion of the object being in the occluded region, a cost associated with the candidate trajectory, wherein the modified trajectory is determined based at least in part on the cost.

J: The one or more non-transitory computer-readable media of paragraph I, wherein determining the cost is based at least in part on at least one of: a number of sensor devices of the vehicle that have a field of view including the object, a capability of the sensor device to capture second data of the object, an amount of the object that is within the field of view of the sensor device, or a ranking of the object.

K: The one or more non-transitory computer-readable media of paragraph J, wherein the ranking of the object is based at least in part on: a classification of the object, a path of the vehicle, or an environmental condition.

L: The one or more non-transitory computer-readable media of paragraph F, wherein the object is at least one of: a traffic light, traffic signage, construction signage, a construction worker, or an emergency vehicle.

M: The one or more non-transitory computer-readable media of paragraph F, wherein the feature is at least one of: a second vehicle, a trailer, particulate matter, or light.

N: The one or more non-transitory computer-readable media of paragraph F, wherein the sensor data is at least one of: current sensor data captured from the sensor device, or map data.

O: The one or more non-transitory computer-readable media of paragraph F, wherein the modified trajectory includes modifying a portion of a height of the vehicle.

P: A method comprising: receiving sensor data; determining, based at least in part on the sensor data, an object in an environment; determining, based at least in part on the sensor data, a feature of the environment; generating a candidate trajectory for a vehicle to follow; determining, based at least in part on the feature and the candidate trajectory, an occluded region within the environment; determining that the occluded region includes at least a portion of the object or a path of the object; determining, based at least in part on the portion of the object being in the occluded region, a modified trajectory to increase an ability of a sensor device to capture data of the object; and controlling the vehicle based at least in part on the modified trajectory.

Q: The method of paragraph P, wherein determining the modified trajectory comprises: determining a degradation in quality of data captured by the sensor device; determining a location of a light source; determining a relative angle between the light source and a heading of the vehicle; determining, based at least in part on map data, the location, and a relative heading, a predicted driving lane that is shaded or occluded from the light source; and determining, based at least in part on the predicted driving lane, the modified trajectory.

R: The method of paragraph P, wherein determining the modified trajectory comprises: determining, for a future time and based at least in part on the feature, the candidate trajectory, and the object, a portion of a driving lane that causes the object to be within a field of view of the sensor device; generating the modified trajectory that instructs the vehicle to navigate to the portion of the driving lane; and controlling the vehicle based at least in part on the modified trajectory.

S: The method of paragraph P, wherein determining the modified trajectory is based at least in part on: determining, based at least in part on the portion of the object being in the occluded region, a cost associated with the candidate trajectory, wherein the modified trajectory is determined based at least in part on the cost.

T: The method of paragraph S, wherein determining the cost is based at least in part on at least one of: a number of sensor devices of the vehicle that have a field of view including the object, a capability of the sensor device to capture second data of the object, an amount of the object that is within the field of view of the sensor device, or a ranking of the object.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing computer-executable instructions that, when executed, cause the system to perform operations comprising:
receiving, from a sensor device associated with a vehicle, sensor data of an environment;
determining, based at least in part on the sensor data, a relevant object in the environment;
determining, based at least in part on the sensor data, a blocking feature of the environment;
generating a candidate trajectory for the vehicle to follow;
determining, based at least in part on the blocking feature and the candidate trajectory, an occluded region within the environment;
determining that the occluded region includes at least a portion of the relevant object;
determining, based at least in part on the portion of the relevant object being in the occluded region, a cost associated with the candidate trajectory;
determining, based at least in part on the cost and the candidate trajectory, a modified trajectory to increase an ability of the sensor device to capture data of the relevant object; and
controlling the vehicle based at least in part on the modified trajectory.

2. The system of claim 1, wherein determining the modified trajectory comprises:
determining a degradation in quality of data captured by the sensor device;
determining a location of a light source;
determining a relative angle between the light source and a heading of the vehicle;
determining, based at least in part on map data, the location, and a relative heading, a predicted driving lane that is shaded or occluded from the light source; and
determining, based at least in part on the predicted driving lane, the modified trajectory.

3. The system of claim 1, wherein determining the modified trajectory comprises:
determining, for a future time and based at least in part on the blocking feature, the candidate trajectory, and the relevant object, a portion of a driving lane that causes the relevant object to be within a field of view of the sensor device;
generating the modified trajectory that instructs the vehicle to navigate to the portion of the driving lane; and
controlling the vehicle based at least in part on the modified trajectory.

4. The system of claim 1, wherein determining the cost is based at least in part on at least one of:
a number of sensor devices of the vehicle that have a field of view including the relevant object,
a capability of the sensor device to capture second data of the relevant object,
an amount of the relevant object that is within the field of view of the sensor device, or
a ranking of the relevant object.

5. The system of claim 1, wherein the blocking feature is at least one of:
a second vehicle,
a trailer,
particulate matter, or
light.

6. One or more non-transitory computer-readable media storing instructions executable by one or more processors, wherein the instructions, when executed, cause a system to perform operations comprising:
receiving sensor data;
determining, based at least in part on the sensor data, an object in an environment;
determining, based at least in part on the sensor data, a feature of the environment;
generating a candidate trajectory for a vehicle to follow;
determining, based at least in part on the feature and the candidate trajectory, an occluded region within the environment;
determining that the occluded region includes at least a portion of the object or a path of the object;
determining, based at least in part on the portion of the object being in the occluded region, a modified trajectory to increase an ability of a sensor device to capture data of the object; and
controlling the vehicle based at least in part on the modified trajectory.

7. The one or more non-transitory computer-readable media of claim 6, wherein determining the modified trajectory comprises:
determining a degradation in quality of data captured by the sensor device;
determining a location of a light source;
determining a relative angle between the light source and a heading of the vehicle;
determining, based at least in part on map data, the location, and a relative heading, a predicted driving lane that is shaded or occluded from the light source; and
determining, based at least in part on the predicted driving lane, the modified trajectory.

8. The one or more non-transitory computer-readable media of claim 6, wherein determining the modified trajectory comprises:
determining, for a future time and based at least in part on the feature, the candidate trajectory, and the object, a portion of a driving lane that causes the object to be within a field of view of the sensor device;
generating the modified trajectory that instructs the vehicle to navigate to the portion of the driving lane; and
controlling the vehicle based at least in part on the modified trajectory.

9. The one or more non-transitory computer-readable media of claim 6, wherein determining the modified trajectory is based at least in part on:
determining, based at least in part on the portion of the object being in the occluded region, a cost associated with the candidate trajectory, wherein the modified trajectory is determined based at least in part on the cost.

10. The one or more non-transitory computer-readable media of claim 9, wherein determining the cost is based at least in part on at least one of:
a number of sensor devices of the vehicle that have a field of view including the object,
a capability of the sensor device to capture second data of the object,
an amount of the object that is within the field of view of the sensor device, or
a ranking of the object.

11. The one or more non-transitory computer-readable media of claim 10, wherein the ranking of the object is based at least in part on:
a classification of the object,
a path of the vehicle, or
an environmental condition.

12. The one or more non-transitory computer-readable media of claim 6, wherein the object is at least one of:
a traffic light,
traffic signage,
construction signage,
a construction worker, or
an emergency vehicle.

13. The one or more non-transitory computer-readable media of claim 6, wherein the feature is at least one of:
a second vehicle,
a trailer,
particulate matter, or
light.

14. The one or more non-transitory computer-readable media of claim 6, wherein the sensor data is at least one of:
current sensor data captured from the sensor device, or map data.

15. The one or more non-transitory computer-readable media of claim 6, wherein the modified trajectory includes modifying a portion of a height of the vehicle.

16. A method comprising:
receiving sensor data;
determining, based at least in part on the sensor data, an object in an environment;
determining, based at least in part on the sensor data, a feature of the environment;
generating a candidate trajectory for a vehicle to follow;
determining, based at least in part on the feature and the candidate trajectory, an occluded region within the environment;
determining that the occluded region includes at least a portion of the object or a path of the object;
determining, based at least in part on the portion of the object being in the occluded region, a modified trajectory to increase an ability of a sensor device to capture data of the object; and
controlling the vehicle based at least in part on the modified trajectory.

17. The method of claim 16, wherein determining the modified trajectory comprises:
determining a degradation in quality of data captured by the sensor device;
determining a location of a light source;
determining a relative angle between the light source and a heading of the vehicle;
determining, based at least in part on map data, the location, and a relative heading, a predicted driving lane that is shaded or occluded from the light source; and
determining, based at least in part on the predicted driving lane, the modified trajectory.

18. The method of claim 16, wherein determining the modified trajectory comprises:
determining, for a future time and based at least in part on the feature, the candidate trajectory, and the object, a portion of a driving lane that causes the object to be within a field of view of the sensor device;
generating the modified trajectory that instructs the vehicle to navigate to the portion of the driving lane; and
controlling the vehicle based at least in part on the modified trajectory.

19. The method of claim 16, wherein determining the modified trajectory is based at least in part on:
determining, based at least in part on the portion of the object being in the occluded region, a cost associated with the candidate trajectory, wherein the modified trajectory is determined based at least in part on the cost.

20. The method of claim 19, wherein determining the cost is based at least in part on at least one of:
a number of sensor devices of the vehicle that have a field of view including the object,
a capability of the sensor device to capture second data of the object,
an amount of the object that is within the field of view of the sensor device, or a ranking of the object.
